(19) United States
(12) Patent Application Publication
(10) Pub. No.: US 2024/0402732 A1
(43) Pub. Date: Dec. 5, 2024

(54) CONTROL DEVICE, NON-TRANSITORY STORAGE MEDIUM AND CONTROL METHOD

(71) Applicant: TOYOTA JIDOSHA KABUSHIKI KAISHA, Aichi-ken (JP)

(72) Inventors: Yuki TAKAHASHI, Miyoshi-shi (JP); Masateru UDATE, Tokyo-to (JP)

(21) Appl. No.: 18/677,889

(22) Filed: May 30, 2024

(30) Foreign Application Priority Data
Jun. 5, 2023 (JP) 2023-092485

(51) Int. Cl. G05D 1/86; G05D 1/617; G05D 101/15

(52) U.S. Cl. CPC G05D 1/86; G05D 1/617; G05D 2101/15

(57) ABSTRACT

A control device tries derivation of a first control command using a first control model, and controls, if the derivation of the first control command by the first control model is normal, a mobile body according to the derived first control command. If an abnormality occurs in the derivation of the first control command by the first control model, the control device controls the mobile body according to a second control command derived from a second control model or a third control command originating from a manual operation by a user. The second control model is configured to be capable of normally deriving the control command in at least a part of scenes of an abnormality occurring in derivation of the control command by the first control model.

### CROSS REFERENCE TO THE RELATED APPLICATION

This application claims the benefit of Japanese Patent Application No. 2023-092485, filed on Jun. 5, 2023, which is hereby incorporated by reference herein in its entirety.

### BACKGROUND

### Technical Field

The present disclosure relates to a control device, a non-transitory storage medium storing a control program, and a control method.

### Description of the Related Art

In Japanese Translation of PCT International Application Publication No. 2019-533810, a system for control of an autonomous vehicle, which is configured to decide a command for the vehicle from a route, GPS data and sensor data using a trained neural network, is proposed.

### SUMMARY

One object of the present disclosure is to provide a control technique for reducing the frequency of occurrence of control by a manual operation.

A control device according to a first aspect of the present disclosure is provided with a storage that stores a first control model and a second control model, and a controller. The second control model is configured to be capable of normally deriving a control command in at least a part of scenes of an abnormality occurring in derivation of a control command by the first control model, by being different from the first control model in at least any of the type and input data. The controller is configured to execute: trying derivation of a first control command using the first control model; controlling, if the derivation of the first control command by the first control model is normal, movement of a mobile body according to the derived first control command; and controlling, if an abnormality occurs in the derivation of the first control command by the first control model, the movement of the mobile body according to a second control command derived by the second control model or a third control command originating from a manual operation by a user. In one example, at least any of the first control model and the second control model may be configured with a trained machine learning model.

A control program according to a second aspect of the present disclosure is a program for causing a control device, the control device holding a first control model and a second control model configured to be capable of normally deriving a control command in at least a part of scenes of an abnormality occurring in derivation of a control command by the first control model, by being different from the first control model in at least any of the type and input data, to execute: trying derivation of a first control command using the first control model; controlling, if the derivation of the first control command by the first control model is normal, movement of a mobile body according to the derived first control command; and controlling, if an abnormality occurs in the derivation of the first control command by the first control model, the movement of the mobile body according to a second control command derived by the second control model or a third control command originating from a manual operation by a user.

A control method according to a third aspect of the present disclosure is an information processing method for a control device, the control device holding a first control model and a second control model configured to be capable of normally deriving a control command in at least a part of scenes of an abnormality occurring in derivation of a control command by the first control model, by being different from the first control model in at least any of the type and input data, to execute: trying derivation of a first control command using the first control model; controlling, if the derivation of the first control command by the first control model is normal, movement of a mobile body according to the derived first control command; and controlling, if an abnormality occurs in the derivation of the first control command by the first control model, the movement of the mobile body according to a second control command derived by the second control model or a third control command originating from a manual operation by a user.

According to the present disclosure, it is possible to expect reduction in the frequency of occurrence of control by a manual operation.

### BRIEF DESCRIPTION OF THE DRAWINGS

FIG. 1 schematically illustrates one example of a scene of the present disclosure being applied;

FIG. 2A schematically illustrates one example of a relationship between a first control model and a second control model according to the present embodiment;

FIG. 2B schematically illustrates one example of the relationship between the first control model and the second control model according to the present embodiment;

FIG. 3 schematically illustrates one example of a control process in the present embodiment;

FIG. 4A schematically illustrates one example of a scene of an abnormality occurring in derivation of a control command in the present embodiment;

FIG. 4B schematically illustrates one example of the scene of an abnormality occurring in derivation of a control command in the present embodiment;

FIG. 4C schematically illustrates one example of the scene of an abnormality occurring in derivation of a control command in the present embodiment;

FIG. 5 schematically illustrates one example of a hardware configuration of a control device according to the present embodiment;

FIG. 6 schematically illustrates one example of a software configuration of the control device according to the present embodiment;

FIG. 7 is a flowchart illustrating one example of a process procedures for control by the control device according to the present embodiment;

FIG. 8 schematically illustrates one example of a control process in another form; and

FIG. 9 is a flowchart illustrating one example of a process procedures for control by the control device according to another form.

### DESCRIPTION OF THE EMBODIMENTS

Conventionally, rule-based self-driving systems have been known. Further, according to a method of Japanese Translation of PCT International Application Publication No. 2019-533810, it is possible to, by using a trained machine learning model, construct a self-driving system. However, the inventor and et al. of the present disclosure found that there is a problem as shown below in the conventional methods.

In other words, neither in the form of the rule-based model nor in the form of the machine learning model, it is not always possible to normally derive a control command. In one example, there may be a case where, in the case of using an image obtained by a camera to derive a control command, the surrounding environment is not on the image due to adhesion of dirt (for example, rain or mud) on the lens of the camera or due to the surroundings being dark, and thus it is not possible to normally derive the control command. In another example, there may be a case where, in the case of using position information to derive a control command, position information cannot be measured, and thus it is not possible to normally derive the control command. In such cases, since self-driving cannot be executed, the vehicle is controlled by manual driving. If, in a deployed control model, the state in which a control command cannot be normally derived frequently occurs, the frequency of control by manual driving increases.

This problem can occur regardless of the type of the vehicle. Further, occurrence of such a problem is not limited to the scene of controlling a vehicle. In the point of controlling movement behavior, the same goes for a mobile body other than a vehicle. Therefore, for all mobile bodies other than a vehicle (for example, a flying object, a vessel, and a robot apparatus), a similar problem can occur in the scenes of controlling the mobile bodies.

In comparison, a control device according to a first aspect of the present disclosure is provided with a storage that stores a first control model and a second control model, and a controller. The second control model is configured to be capable of normally deriving a control command in at least a part of scenes of an abnormality occurring in derivation of a control command by the first control model, by being different from the first control model in at least any of the type and input data. The controller is configured to execute: trying derivation of a first control command using the first control model; controlling, if the derivation of the first control command by the first control model is normal, movement of a mobile body according to the derived first control command; and controlling, if an abnormality occurs in the derivation of the first control command by the first control model, the movement of the mobile body according to a second control command derived by the second control model or a third control command originating from a manual operation by a user.

In the first aspect of the present disclosure, the second control model capable of deriving a control command from a different point of view by being different in at least any of the model type and input to be accepted is deployed together with the first control model. By being configured to derive a control command from the different point of view, a range in which a control command can be normally derived by the second control model can be different from that of the first control model. That is, the second control model can be expected to be capable of normally deriving a control command at least in a part of scenes in which it is impossible to normally derive a control command with the first control model. Therefore, at least in the part of the scenes in which it is impossible to normally derive a control command with the first control model, automatic control by the second control model can be executed. That is, it is possible to support at least a part of a range in which operation of the first control model is difficult, by the second control model. Therefore, according to the first aspect of the present disclosure, it is possible to reduce the frequency of control by a manual operation.

As another form of the control device according to the above aspect, one aspect of the present disclosure may be an information processing method that realizes all or a part of each component described above, may be a program, or may be a non-transitory storage medium that can be read by a machine such as a computer, in which such a program is stored. Here, the machine-readable storage medium is a medium in which information such as a program is accumulated by electrical, magnetic, optical, mechanical, or chemical action.

For example, a control program according to a second aspect of the present disclosure is a program for causing a control device, the control device holding a first control model and a second control model configured to be capable of normally deriving a control command in at least a part of scenes of an abnormality occurring in derivation of a control command by the first control model, by being different from the first control model in at least any of the type and input data, to execute: trying derivation of a first control command using the first control model; controlling, if the derivation of the first control command by the first control model is normal, movement of a mobile body according to the derived first control command; and controlling, if an abnormality occurs in the derivation of the first control command by the first control model, the movement of the mobile body according to a second control command derived by the second control model or a third control command originating from a manual operation by a user.

Further, a control method according to a third aspect of the present disclosure is an information processing method for a control device, the control device holding a first control model and a second control model configured to be capable of normally deriving a control command in at least a part of scenes of an abnormality occurring in derivation of a control command by the first control model, by being different from the first control model in at least any of the type and input data, to execute: trying derivation of a first control command using the first control model; controlling, if the derivation of the first control command by the first control model is normal, movement of a mobile body according to the derived first control command; and controlling, if an abnormality occurs in the derivation of the first control command by the first control model, the movement of the mobile body according to a second control command derived by the second control model or a third control command originating from a manual operation by a user.

Hereinafter, an embodiment according to one aspect of the present disclosure (hereinafter also referred to as “the present embodiment”) will be described based on drawings. The present embodiment described below, however, is a mere exemplification of the present disclosure in all points. Various improvements or modification may be made without departing from the scope of the present disclosure. In implementing the present disclosure, a specific configuration according to each embodiment may be appropriately adopted. Data that appears in the present embodiment is described in a natural language. More specifically, however, the data is specified in pseudo language, commands, parameters, a machine language, and the like that a computer can recognize.

### 1. Application Example

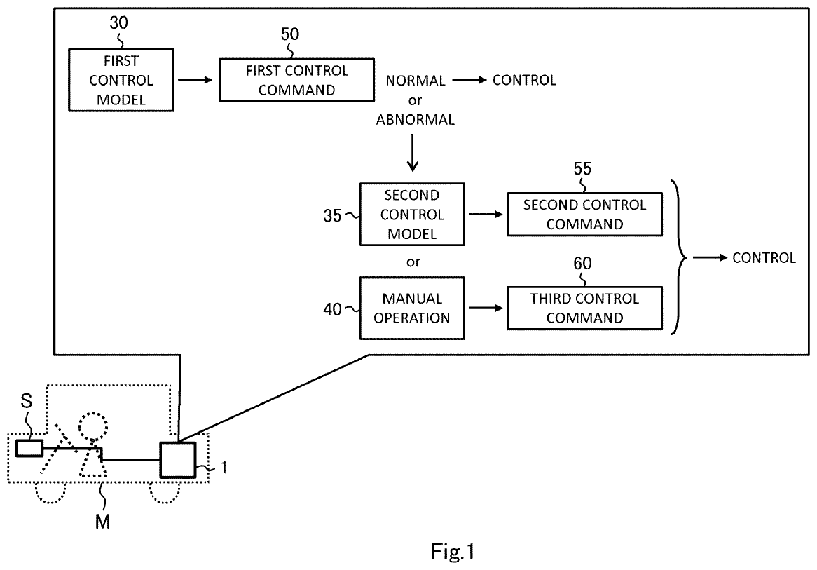

FIG. 1 schematically illustrates one example of a scene of the present disclosure being applied. A control device 1 according to the present embodiment is one or more computers configured to control automatic movement of a target mobile body M.

In the present embodiment, the control device 1 is mounted on the mobile body M and holds a first control model 30 and a second control model 35. Each of the first control model 30 and the second control model 35 is configured to be capable of deriving a control command in order to automatically control movement of the mobile body M. The second control model 35 is configured to be capable of normally deriving a control command in at least a part of scenes of an abnormality occurring in derivation of a control command by the first control model 30, by being different from the first control model 30 in at least any of the model type and input data to be accepted.

In the present embodiment, the control device 1 tries derivation of a first control command 50 using the first control model 30. In this trial, if the first control model 30 is operated under appropriate conditions for the first control model 30, the first control command 50 can be normally derived. In comparison, if the first control model 30 is not operated under the appropriate conditions, for example, like the case of an image not being normally obtained or the case of position information not being obtained, there is a possibility that the first control command 50 is not normally derived (that is, an abnormality occurs in derivation of the first control command 50).

If the derivation of the first control command 50 by the first control model 30 is normal, the control device 1 controls the movement of the mobile body M according to the derived first control command 50. On the other hand, if an abnormality occurs in the derivation of the first control command 50 by the first control model 30, the control device 1 controls the movement of the mobile body M according to a second control command 55 derived by the second control model 35 or a third control command 60 originating from a manual operation 40 by a user.

As described above, in the present embodiment, the second control model 35 capable of deriving a control command from a different point of view is deployed together with the first control model 30. Thereby, it can be expected to be able to normally derive a control model (the second control command 55) by the second control model 35 in at least a part of scenes in which it is impossible to normally derive a control command (the first control command 50) with the first control model 30. Therefore, even if an abnormality occurs in derivation of the first control command 50 by the first control model 30, continuation of automatic control by the second control model 35 can be expected. That is, it is possible to support at least a part of a range in which operation of the first control model 30 is difficult, by the second control model 35. If the automatic control can be continued by the second control model 35, there is no need to switch to control by the manual operation 40. Therefore, according to the present embodiment, it is possible to reduce the frequency of control by a manual operation.

### (Mobile Body)

The type of the mobile body M may be appropriately selected according to each embodiment if the mobile body M can automatically move by mechanical control. The mobile body M may be a movable apparatus, for example, a vehicle, a flying object, a vessel, and a robot apparatus. The flying body may be at least any of an unmanned aircraft such as a drone and a manned aircraft.

In one example, the mobile body M may be a vehicle as illustrated in FIG. 1. In this case, in a scene of implementing automatic travel of the vehicle, the frequency of control by a manual operation can be reduced. When the mobile body M is a vehicle, the type of the vehicle (the number of wheels, a power source, the size, and the like) may be freely selected. The vehicle may be selected from among, for example, a two-wheeled vehicle, a three-wheeled vehicle, and a four-wheeled vehicle. The power source of the vehicle may be selected from among, for example, electricity and fuel. When the vehicle is a car, the size of the vehicle may be selected from among large, mid-size, semi-mid-size, standard, special large, special small, and the like. When the vehicle is a two-wheeled vehicle, the size of the vehicle may be selected from among large, standard, and the like. As a typical example, the mobile body M may be a car with a self-driving capability of Level 2 or higher. The user may be any person related to the mobile body M. When the mobile body M is a vehicle, the user may typically be a driver.

### (Controlling)

In one example, controlling the operation of the target mobile body M may be configured with directly controlling the target mobile body M. That is, the control device 1 may be configured to directly control the target mobile body M. In another example, the mobile body M may be provided with a dedicated control device such as a controller. In this case, controlling the operation of the target mobile body M by the control device 1 may be configured with indirectly controlling the target mobile body M by giving a derivation result to the dedicated control device.

The control device 1 may be deployed in any place. In one example, the control device 1 may be mounted on the mobile body M as illustrated in FIG. 1. The mounting place may be freely decided, and, for example, the control device 1 may be attached inside or outside the mobile body M. In another example, the control device 1 may be arranged apart from the mobile body M and configured to remotely control the mobile body M. The control device 1 may be wiredly or wirelessly connected to the mobile body M.

### (Control Models)

Each of the first control model 30 and the second control model 35 is constructed to derive a control command according to an environment of the mobile body M. The environment is a phenomenon observed by at least either the mobile body M itself or the surroundings. In one example, at least a part of environments may be observed by one or more sensors S arranged inside or outside the mobile body M. The types of the sensors S do not have to be particularly limited but may be appropriately selected according to each embodiment if any environment in which the mobile body M moves can be observed. In one example, the one or more sensors S may include a camera (an image sensor), a radar, aLiDAR (light detection and ranging) sensor, a sonar (an ultrasonic sensor), an infrared sensor, a GNSS (global navigation satellite system)/GPS (Global Positioning Satellite) module, and the like.

The form of input/output of the control models (the first control model 30 and the second control model 35) do not have to be particularly limited but may be appropriately selected according to each embodiment if a control command can be derived from an environment of a mobile body (the mobile body M). In one example, at least any of the first control model 30 and the second control model 35 may be configured to derive a control command from observation data of the sensors at one or more points of time. In another example, at least any of the first control model 30 and the second control model 35 may be configured to derive a control command from a result of recognition of a surrounding environment. The result of recognition of a surrounding environment may be obtained by analyzing the observation data of the sensors by any method (that is, using an analysis model). The control device 1 may be further provided with the analysis model that infers the result of recognition of a surrounding environment from the observation data of the sensors. In one example, the analysis model may be configured to obtain the result of recognition of a surrounding environment from the observation data based on rules by executing analysis processing such as pattern matching and edge detection. In another example, the analysis model may be configured with a trained machine learning model. The analysis model may be regarded as a part of a control model or may be regarded as a separate component from the control models. To inputs of the control models, other information may be optionally added. The control models may be configured to further accept input of any information such as a set speed, a speed limit, a position, map information, navigation information, and the like.

Further in one example, the control models (the first control model 30 and the second control model 35) may be configured to directly output a control command. In another example, the control models may be configured to indirectly output a control command so that the control command may be obtained by executing any information processing (for example, an interpretation processing such as determination and selection) for an output of each of the control models. The control command may be configured to directly show, for example, the amount of control of the mobile body M (a control instruction value or a control output amount) such as an accelerator control amount, a brake control amount, a steering angle of a steering wheel, or the like. Or alternatively, the control command may be configured to indirectly show the amount of control of the mobile body M, for example, like a path, a state after control, and the like. In this case, the amount of control of the mobile body M may be obtained from the control command by executing any information processing. In one example, when the mobile body M is a vehicle, the amount of control of the vehicle may be obtained by applying an inference result obtained from a control model to a vehicle model. The vehicle model may have various kinds of parameters for the accelerator, the brake, and steering of the steering wheel and may be appropriately configured to derive the control amount from indirect information (a path, a state after control, and the like) An output format of each of the first control model 30 and the second control model 35 may be freely selected. In one example, one of the first control model 30 and the second control model 35 may be configured to directly output a control command, and the other may be configured to indirectly output a control command.

The configuration of each of the first control model 30 and the second control model 35 may be appropriately selected according to each embodiment. In one example, each of the control models (the first control model 30 and the second control model 35) may be configured with a trained machine learning model (for example, an end-to-end model), a rule-based model, or a combination thereof.

The rule-based model is configured to collate a given input (for example, observation data, or information showing an environment, such as a result of recognition of a surrounding environment) with rules and derive a control command according to a result of the collation (according to applicable rules). The rules may be manually set, or at least a part thereof may be automatically set.

The machine learning model is configured to have one or more arithmetic parameters that can be adjusted by machine learning. The one or more arithmetic parameters are used for arithmetic operation for intended inference (in the present disclosure, derivation of a control command). Machine learning is to adjust (optimize) values of the arithmetic parameters using learning data. The machine learning model may be configured, for example, with a neural network, a support vector machine, a regression model, or a decision tree model. A method for machine learning may be appropriately selected (for example, the error backpropagation method) according to an adopted machine learning model.

As one example, at least any of the first control model 30 and the second control model 35 may be configured with a neural network. The structure of the neural network may be appropriately decided according to each embodiment and may be identified, for example, by the number of layers from the input layer to the output layer, the types of the layers, the number of nodes (neurons) included in each layer, and a connection relationship among the nodes of each layer. In one example, the neural network may have a recursive structure. Further, the neural network may include any layer, for example, a fully connected layer, a convolution layer, a pooling layer, a deconvolution layer, an unpooling layer, a normalization layer, a dropout layer, or an LSTM (long short-term memory). The neural network may have any mechanism such as an attention mechanism. The neural network may include any model such as a GNN (graph neural network), a diffusion model, or a generation model (for example, a generative adversarial network or a transformer). When a neural network is used as a control model, weights of connections among nodes included in the control model and thresholds for the nodes are examples of the arithmetic parameters. In the case of adopting a machine learning model, the control model may be configured to have an end-to-end model structure.

### (Relationship Between First Control Model and Second Control Model)

In the present embodiment, the first control model 30 is mainly used to control the mobile body M, and the second control model 35 is secondarily used to control the mobile body M as alternative means at the time of an output failure (an abnormality) of the first control model 30. That is, the second control model 35 is used to support the first control model 30. The first control model 30 and the second control model 35 are configured such that at least either their model types or pieces of input data to be accepted (given pieces of data) are mutually different. Thereby, the second control model 35 is configured to be capable of normally deriving a control command in at least a part of scenes of an abnormality occurring in derivation of a control command by the first control model 30.

The model types being different means that the arithmetic processes for inference processing are different. If the arithmetic processes for inference processing are different, conditions that cause a control command derivation failure can be different. The model types being different may be realized, for example, by adopting a machine learning model as the first control model 30 and adopting a rule-based model as the second control model 35 or by adopting machine learning models with mutually different structures as the first control model 30 and the second control model 35. In one example, a neural network with a recursive structure and a neural network without a recursive structure may be adopted as the first control model 30 and the second control model 35, respectively.

The given pieces of input data being different may be configured with at least either the types of at least parts of the pieces of input data given to the control models being different or the resolutions (the information amounts) being different though the types of the pieces of input data are the same. If the types of at least parts of the pieces of input data are different, conditions under which the pieces of input data can be normally obtained can also be different, so that the conditions that cause a control command derivation failure can also be different. The same goes for the case where the resolutions are different (in general, low-resolution data is easier to normally obtain than high-resolution data). As one example, one of the first control model 30 and the second control model 35 is configured such that image data and other data (for example, position information, map information, and navigation information) are inputted while the other may be configured such that only image data is inputted. As another example, one of the first control model 30 and the second control model 35 is configured such that high-resolution data (for example, position information and image data) is inputted while the other may be configured such that low-resolution data is inputted. In this case, the first control model 30 and the second control model 35 may be configured to accept input of high-resolution data and input of low-resolution data, respectively. In the present embodiment, the first control model 30 and the second control model 35 can be configured to be different in at least a part of scenes in which it is possible to normally derive a control command, by at least either the model types being different or the pieces of input data being different.

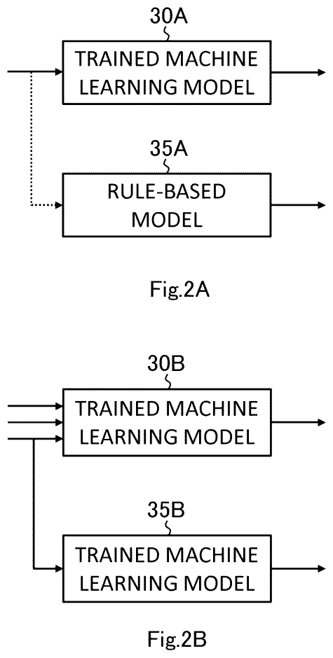

FIG. 2A schematically illustrates one example of a relationship between the first control model 30 and the second control model 35 according to the present embodiment. In the example of FIG. 2A, the first control model 30 is configured with a trained machine learning model 30A, and the second control model 35 is configured with a rule-based model 35A. In one example, the trained machine learning model 30A may have an end-to-end model structure. Further, in one example, the rule-based model 35A may be configured to recognize a surrounding environment from at least a part of observation data obtained by the sensors, collate a result of the recognition of the surrounding environment with rules, and derive a control command according to a result of the collation (according to applicable rules). The rule-based model 35A may include an analysis model to recognize the surrounding environment.

In general, a rule-based model derives a control command according to rules. Therefore, in comparison with a machine learning model, the process for deriving a control command is clearer, and the operation of the rule-based model is easy to predict. Therefore, according to this example, in scenes of a failure occurring in derivation of a control command by the first control model 30, continuation of stable automatic control of the mobile body M by the second control model 35 the operation of which is highly predictable can be expected. Inputs of the trained machine learning model 30A and the rule-based model 35A may be appropriately selected according to each embodiment. The inputs of the trained machine learning model 30A and the rule-based model 35A may be the same or may be mutually different.

FIG. 2B schematically illustrates another example of the relationship between the first control model 30 and the second control model 35 according to the present embodiment. In the example of FIG. 2B, the first control model 30 is configured with a trained machine learning model 30B. The second control model 35 is configured with a trained machine learning model 35B the input data of which is at least partially different from that of the first control model 30 (the trained machine learning model 30B).

In one example, the input data of one of the trained machine learning model 30B and the trained machine learning model 35B may be configured only with a part of the input data of the other. As a specific example, as illustrated in FIG. 2B, the trained machine learning model 30B is configured to accept input of a plurality of types of data (for example, image data and other data) while the second control model 35 may be configured to accept input of only a part of the data (for example, only image data).

In another example, the pieces of input data of the trained machine learning model 30B and the trained machine learning model 35B may be configured to be partially overlapped and different in other parts. As a specific example, the trained machine learning model 30B is configured to accept input of first data and second data (for example, image data and position information) while the trained machine learning model 35B may be configured to accept input of the first data and third data (for example, image data and LiDAR data). Each of the pieces of first to third data may be configured with one or more types of data.

In still another example, the pieces of input data of the trained machine learning model 30B and the trained machine learning model 35B may be configured to be completely different. As a specific example, the trained machine learning model 30B is configured to accept input of only the first data (for example, image data/position information) while the trained machine learning model 35B may be configured to accept input of only the second data (for example, position data/image data). Each of the first data and the second data may be configured with one or more types of data.

In the case of adopting a form in which the types of pieces of input data of the trained machine learning models (30B and 35B) are overlapped, resolutions (information amounts) of the pieces of input data of the models may be different. As a specific example, one of the trained machine learning models (30B and 35B) is configured to accept input of high-resolution data (for example, image data and position information) while the other may be configured to accept input of low-resolution data. In one example, the trained machine learning model 30B is configured to accept input of high-resolution data while the trained machine learning model 35B may be configured to accept input of low-resolution data. High-resolution and low-resolution refer to a relationship between inputted pieces of data and is configured by the amount of data of the same type inputted to one being different from that of the other. In the case of a form in which resolutions are different, the types of pieces of input data of the trained machine learning models (30B and 35B) may match perfectly one another.

By the pieces of input data being at least partially different between the first control model 30 (the trained machine learning model 30B) and the second control model 35 (the trained machine learning model 35B), pieces of data (explanatory variables) used to derive (infer) a control command are different. Thereby, conditions under which input data is obtained that can be used for normal derivation of a control command can be different. Therefore, it is possible to cause the first control model 30 and the second control model 35 to be different in a range within which a control command derivation failure occurs. Therefore, according to this example, in at least a part of the scenes of a failure occurring in derivation of a control command by the first control model 30, continuation of the automatic control by the second control model 35 can be expected.

In the case of adopting this form, in one example, the second control model 35 (the trained machine learning model 35B) may be configured such that an arithmetic load is reduced by at least either the amount of input data being less or the number of arithmetic parameters being smaller in comparison of the first control model 30 (the trained machine learning model 30B) Thereby, it is possible to, while preventing increase in the arithmetic load, reduce the frequency of control by a manual operation.

Further, in one example, the first control model 30 (the trained machine learning model 30B) is trained for general purposes while the second control model 35 (the trained machine learning model 35B) may be exclusively trained. Or alternatively, though the first control model 30 is also exclusively trained, the second control model 35 may be trained more exclusively in comparison with the first control model 30. Exclusively performing training may be configured with performing training so that the second control model 35 easily demonstrates its performance on particular domains in comparison with the first control model 30, for example, limiting domains of training samples (using training samples originating from local domains for machine learning). As a specific example, when the mobile body M is a vehicle, domains of training samples may be limited by preferentially training samples related to travel in a tunnel, preferentially training samples related to travel in a particular area, or the like. As a domain of a training sample used for machine learning, a domain on which a failure of derivation by a control model trained for general purposes (the trained machine learning model 30B) easily occurs. Thereby, it is possible to increase the probability that, when the first control model 30 (the trained machine learning model 30B) fails in derivation on a particular domain, the automatic control can be continued by the second control model 35 (the trained machine learning model 35B).

### (Control Command)

The control commands (the first control command 50, the second control command 55, and the third control command 60) relate to operation of the mobile body M. The configuration of each control command may be appropriately selected according to each embodiment. In one example, the control command may be configured by acceleration, deceleration, steering, or a combination thereof. Acceleration and deceleration may include gear change. When at least any of acceleration, deceleration, and steering is included, the control command may be expressed by a path. Accordingly, the control models (the first control model 30 and the second control model 35) may be expressed as path planners. Further, the control command may further include a command about an operation of the mobile body M. As one example, when the mobile body M is a vehicle, the control command may include a vehicle operation for blinkers, a hazard lamp, a horn, or communication processing (for example, transmission of data to a center or making an emergency call).

### (Assignment of Second Control Model or Manual Operation)

Which of execution of the automatic control by the second control model 35 and execution of the control by the manual operation 40 is to be assigned when an abnormality occurs in derivation of the first control command 50 by the first control model 30 may be appropriately decided according to each embodiment. As one simple example, controlling movement of the mobile body M according to the second control command 55 or the third control command 60 may be configured with controlling, if derivation of the second control command 55 by the second control model 35 is normal, the movement of the mobile body M according to the derived second control command 55, and controlling, if an abnormality occurs in the derivation of the second control command 55 by the second control model 35, the movement of the mobile body M according to the third control command 60 originating from the manual operation 40.

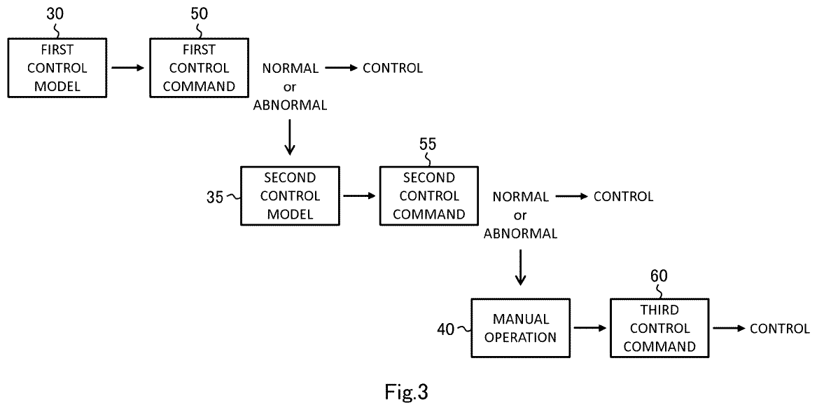

FIG. 3 schematically illustrates one example of a control process in the control device 1 according to the present embodiment. In the one example of FIG. 3, the control device 1 tries derivation of the first control command 50 by the first control model 30. If the first control command 50 is normally derived as a result of the trial of derivation of the first control command 50, the control device 1 controls operation of the mobile body M according to the derived first control command 50. On the other hand, if an abnormality occurs in derivation of the first control command 50, the control device 1 tries derivation of the second control command 55 by the second control model 35. The trial of derivation of the second control command 55 by the second control model 35 may be executed regardless of whether derivation of the first control command 50 is successful or not.

If the second control command 55 is normally derived as a result of the trial of derivation of the second control command 55, the control device 1 controls the operation of the mobile body M according to the derived second control command 55. On the other hand, if an abnormality occurs in derivation of the second control command 55, the control device 1 accepts input of the manual operation 40 and controls the operation of the mobile body M according to the third control command 60 originating from the inputted manual operation 40. Thereby, the control mode is switched in order of the first control model 30, the second control model 35 and the manual operation 40, and, therefore, it is possible to secure the possibility of continuation of execution of the automatic control by the second control model 35. As a result, it is possible to reduce the frequency of control by a manual operation.

The acceptance of the manual operation 40 may be executed at any timing. The control device 1 may accept input of the manual operation 40 while the automatic control by the first control model 30 or the second control model 35 is being executed. The control device 1 may switch from the automatic control mode by the first control model 30 or the second control model 35 to the control mode of the manual operation 40 in response to any operation by the user. In the case of switching from the automatic control by the first control model 30 or the second control model 35 to the manual control by the manual operation 40, the control device 1 may control the operation of the mobile body M according to the third control command 60 originating from the manual operation 40 by discarding (ignoring) a control command derived by the control model or by overlapping the derived control command. Discarding may be switching from the automatic control to the manual control immediately, that is, switching from control by the control command derived from the control model to control according to the manual operation 40 by the user immediately. On the other hand, overlapping may be switching from the automatic control to the manual control (user control) gradually.

### (Abnormality)

An abnormality occurring in derivation of a control command (the first control command 50 or the second control command 55) by a control model (the first control model 30 or the second control model 35) may include all such cases where a normal control command cannot be obtained.

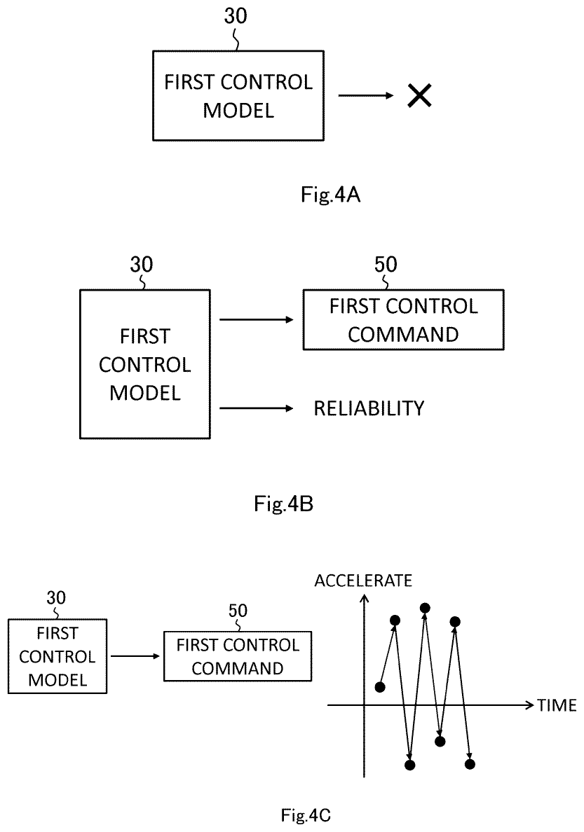

Each of FIGS. 4A, 4B, and 4C schematically illustrates one example of the scene of an abnormality occurring in derivation of a control command in the control device 1 according to the present embodiment.

In the example of FIG. 4A, an abnormality occurring in derivation of the first control command 50 by the first control model 30 includes an output failure of the first control command 50 occurring. The output failure may be at least any of meaningful output from which a control command can be derived not being made, an error signal being outputted, or nothing being outputted.

In the example of FIG. 4B, an abnormality occurring in derivation of the first control command 50 by the first control model 30 includes the reliability of output of the first control model 30 being below a threshold. The threshold may be freely decided. A case where the reliability is equal to the threshold may be classified in either of the abnormal and normal cases.

The reliability may be acquired in any method. In one example, as illustrated in FIG. 4B, the first control model 30 may be configured to be capable of outputting the reliability of an inference result together with the inference result in any method such as the reliability being given as a teacher signal at the time of training in machine learning (that is, the reliability is attached to training data).

In another example, the reliability may be calculated from an output of the first control model 30. For example, when the first control model 30 includes an autoencoder, the control device 1 may calculate a reconfiguration error of the autoencoder as the reliability. In this case, the control device 1 may evaluate the reliability being lower as the reconfiguration error is larger. Further, for example, when an output of the first control model 30 includes a result of class identification, the control device 1 may calculate an inter-class entropy as the reliability. In this case, the control device 1 may evaluate the reliability being lower as the value of the entropy is larger. In still another example, the control device 1 may calculate the reliability from the first control command 50 derived by the first control model 30 in any analysis processing such as simulation.

In the example of FIG. 4C, an abnormality occurring in derivation of the first control command 50 by the first control model 30 includes the amount of change in output of the first control model 30 per unit time being above a threshold. The threshold may be freely decided. A case where the amount of change is equal to the threshold may be classified in either of the abnormal and normal cases. Basically, due to stable automatic control, the amount of change in control commands derived from each control model does not increase. Therefore, it is possible to determine whether derivation of a control command is successful or not according to the amount of change in output of each control model.

In one example, as illustrated in FIG. 4C, the amount of change in output may be calculated from variation in results of derivation of first control commands 50. FIG. 4C illustrates an example of calculating the amount of change in speed of acceleration or deceleration as the amount of change in output. In another example, as a simple method, the amount of change in output may be calculated from variation in output values of the first control model 30. Further the amount of change in output may be calculated in any method. In one example, the amount of change in output may be calculated as a time integral of differences during a predetermined period (a total of differences between t and t+1).

In the present embodiment, an abnormality occurring in derivation of the first control command 50 may include at least any of the above three cases. Thereby, in at least any of the above three cases, it is possible to determine a failure in derivation of a control command by the first control model 30, and switch from the automatic control by the first control model 30 to the automatic control by the second control model 35 according to a result of the determination. The same may go for an abnormality occurring in deviation of the second control command 55 when the first control model 30 is replaced with the second control model 35.

### 2. Configuration Example

### Hardware Configuration Example

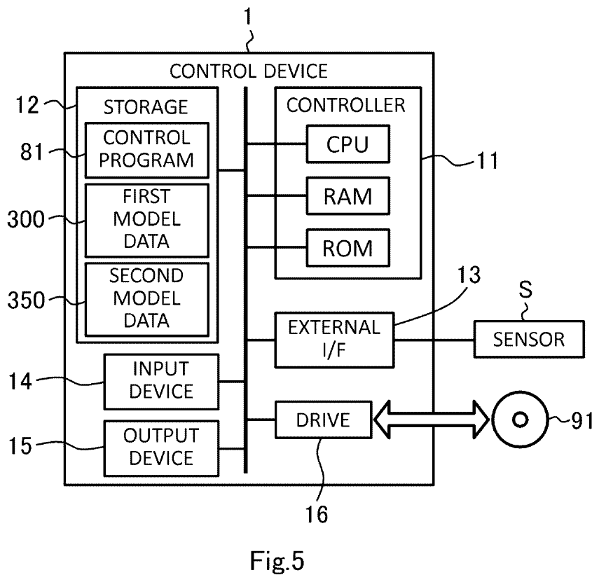

FIG. 5 schematically illustrates one example of a hardware configuration of the control device 1 according to the present embodiment. The control device 1 according to the present embodiment is a computer to which a controller 11, a storage 12, an external interface 13, an input device 14, an output device 15, and a drive 16 are electrically connected.

The controller 11 includes a CPU (central processing unit) which is a hardware processor, a RAM (random access memory), a ROM (read-only memory), and the like and is configured to execute any information processing based on a program and various kinds of data. The controller 11 (the CPU) is one example of a processor resource.

The storage 12 may be configured, for example, with a hard disk drive, a solid-state drive, and the like. The storage 12 (and the RAM and the ROM) are examples of memory resources. In the present embodiment, the storage 12 stores various kinds of information such as a control program 81, first model data 300, and second model data 350.

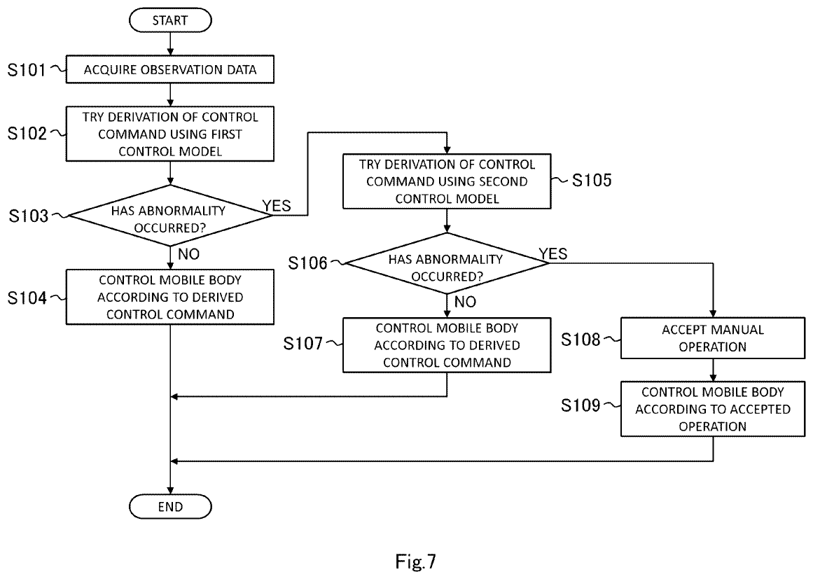

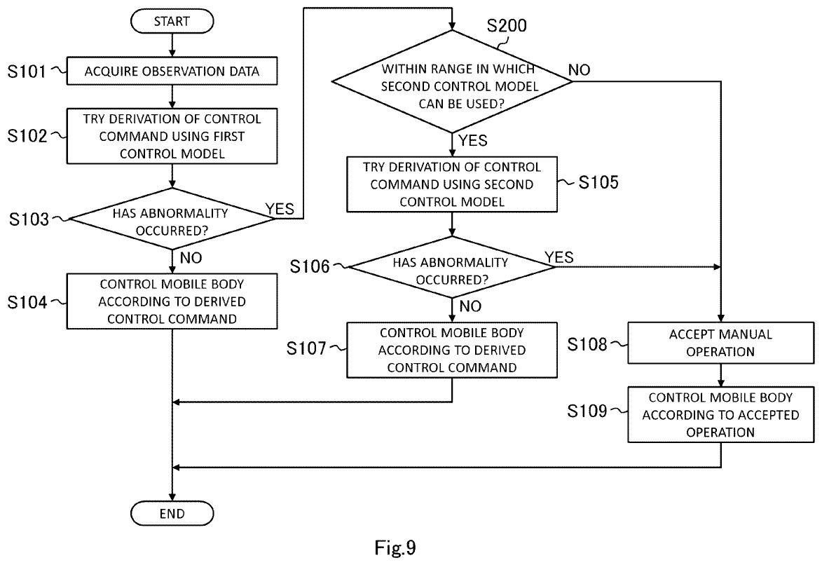

The control program 81 is a program for causing the control device 1 to execute information processing for control of the mobile body M (FIGS. 7 and 9 to be described later). The control program 81 includes a series of instructions of the information processing. The first model data 300 is configured to include information about the first control model 30. The second model data 350 is configured to include information about the second control model 35. In one example, when at least one of the first control model 30 and the second control model 35 is configured with a trained machine learning model, at least one of the first model data 300 and the second model data 350 may include information showing values of arithmetic parameters adjusted by machine learning. In some cases, at least one of the first model data 300 and the second model data 350 may further include information showing a configuration (for example, a neural network structure) of the machine learning model. In another example, when at least one of the first control model 30 and the second control model 35 is configured with a rule-based model, at least one of the first model data 300 and the second model data 350 may include information showing rules in the rule-based model.

The external interface 13 may be, for example, a USB (universal serial bus) port, a dedicated port, or a wireless communication port and is configured to wiredly or wirelessly connect to an external apparatus. In the present embodiment, the control device 1 may be connected to the sensors S via the external interface 13. The control device 1 may be connected to any of the components (for example, an operation tool) of the mobile body M via the external interface 13.

The input device 14 is a device for performing input, for example, a mouse, a keyboard, and an operator. The output device 15 is a device for performing output, for example, a display, a speaker, and the like. The user can operate the control device 1 by using the input device 14 and the output device 15. The input device 14 and the output device 15 may be integrally configured, for example, with a touch panel display.

The drive 16 is a device for reading various kinds of information such as a program stored in a storage medium 91. At least any of the control program 81, the first model data 300, and the second model data 350 described above may be stored in the storage medium 91 instead of or the same as in the storage 12. In order that a machine such as a computer can read the various kinds of information (the stored program and the like), the storage medium 91 is configured to accumulate the information by electrical, magnetic, optical, mechanical, or chemical action. The control device 1 may acquire at least any of the control program 81, the first model data 300 and the second model data 350 described above from the storage medium 91. The storage medium 91 may be a disc-type storage medium such as a CD or a DVD, or may be a storage medium other than the disc-type, such as a semiconductor memory (for example, a flash memory). The type of the drive 16 may be appropriately selected according to the type of the storage medium 91.

As for a specific hardware configuration of the control device 1, omission, replacement, and addition of the components can be appropriately performed according to each embodiment. For example, the controller 11 may include a plurality of hardware processors. The hardware processors may be configured with a microprocessor, an FPGA (field-programmable gate array), a DSP (digital signal processor), ECU (electronic control unit), GPU (graphics processing unit), and the like. At least any of the external interface 13, the input device 14, the output device 15, and the drive 16 may be omitted. The control device 1 may be a general-purpose computer, a mobile telephone including a smartphone, a tablet PC (personal computer), or any of other terminal devices, in addition to a computer designed exclusively for a service to be provided. When the mobile body M is a vehicle, the control device 1 may be an in-vehicle device.

### Software Configuration Example

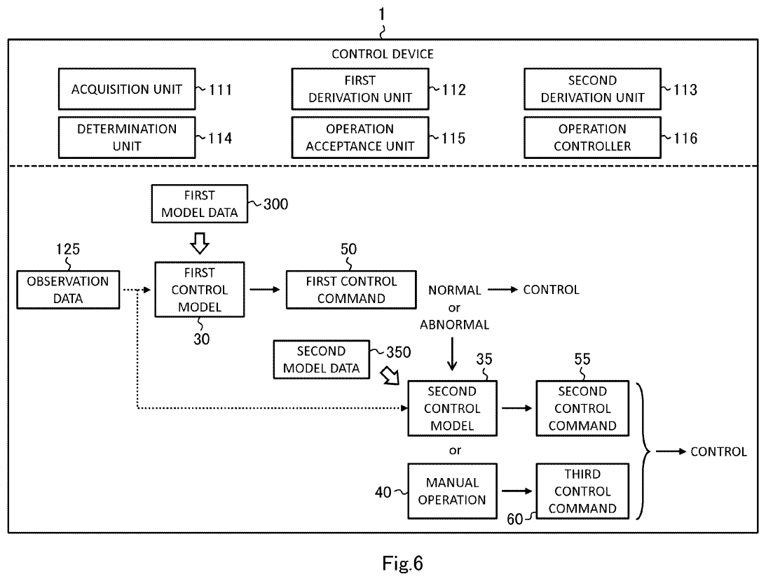

FIG. 6 schematically illustrates one example of a software configuration of the control device 1 according to the present embodiment. The controller 11 of the control device 1 develops the control program 81 stored in the storage 12 on the RAM, and executes the instructions included in the control program 81 by the CPU. Thereby, the control device 1 operates as a computer provided with an acquisition unit 111, a first derivation unit 112, a second derivation unit 113, a determination unit 114, an operation acceptance unit 115, and an operation controller 116 as software modules. That is, in the present embodiment, each software module of the control device 1 is realized by the controller 11 (the CPU).

The acquisition unit 111 is configured to acquire observation data 125 of the sensors S. The first derivation unit 112 is provided with the first control model 30 by holding the first model data 300. The first derivation unit 112 is configured to derive the first control command 50 using the first control model 30. In the present embodiment, the first derivation unit 112 may be configured to derive the first control command 50 from at least a part of the acquired observation data 125 using the first control model 30. The second derivation unit 113 is provided with the second control model 35 by holding the second model data 350. The second derivation unit 113 is configured to derive the second control command 55 using the second control model 35. In the present embodiment, the second derivation unit 113 may be configured to derive the second control command 55 from at least a part of the acquired observation data 125 using the second control model 35.

The determination unit 114 is configured to determine whether derivation of the control commands (the first control command 50 and the second control command 55) by the control models (the first control model 30 and the second control model 35) is normal or not. The operation acceptance unit 115 is configured to accept input of the manual operation 40 by the user and acquire the third control command 60 originating from the inputted manual operation 40. The operation controller 116 is configured to, if derivation of the first control command 50 by the first control model 30 is normal, control movement of the mobile body M according to the derived first control command 50. Furthermore, the operation controller 116 is configured to, if an abnormality occurs in the derivation of the first control command 50 by the first control model 30, control the movement of the mobile body M according to the second control command 55 derived by the second control model 35 or the third control command 60 originating from the manual operation 40 by the user.

In the present embodiment, description is made on a case where all the software modules of the control device 1 are realized by a general-purpose CPU. A part or all of the above software modules, however, may be realized by one or more dedicated processors. Each of the above modules may be realized by a hardware module. As for the software configuration of the control device 1, omission, replacement, and addition of modules may be appropriately performed.

### 3. Operation Example

FIG. 7 illustrates one example of a process procedures for control of the mobile body M by the control device 1 according to the present embodiment. The process procedure below is one example of a control method executed by a computer. The process procedure below, however, is a mere example, and each step may be changed as far as possible. Further, as for the process procedure below, omission, replacement, and addition of steps can be appropriately performed according to each embodiment.

### (Step S101)

At step S101, the controller 11 operates as the acquisition unit 111 and acquires the observation data 125 of the sensors S. A route for acquiring the observation data 125 may be freely selected. In one example, the control device 1 may be directly connected to the sensors S, and the controller 11 may directly acquire the observation data 125 from the sensors S. In another example, the controller 11 may indirectly acquire the observation data 125 from the sensors S via another computer. When having acquired the observation data 125, the controller 11 advances the process to the next step S102.

### (Step S102)

At step S102, the controller 11 operates as the first derivation unit 112 and tries derivation of the first control command 50 using the first control model 30. A process for deriving the first control command 50 may be appropriately decided according to each embodiment.

As one example, when the first control model 30 includes a trained machine learning model, the controller 11 may input at least a part of the acquired observation data 125 to the first control model 30 to execute arithmetic processing (for example, forward-propagation arithmetic processing) of the first control model 30. As a result of the arithmetic processing, the controller 11 may acquire an output value corresponding to an inference result (a result of direct or indirect control command derivation) from the first control model 30. In this case, the controller 11 refers to the first model data 300 at any timing before implementing step S102 to set up the first control model 30 (a trained machine learning model) into a state in which the arithmetic processing can be executed.

As another example, when the first control model 30 includes a rule-based model, the controller 11 refers to the first model data 300 to derive the first control command 50 from an environment shown by at least a part of the observation data 125 according to rules specified by the rule-based model. When the rule-based model includes an analysis model, the controller 11 may recognize a surrounding environment of the mobile body M from at least the part of the observation data 125 using the analysis model and derive the first control command 50 from a result of the recognition according to the rules.

When having tried derivation of the first control command 50, the controller 11 advances the process to the next step S103.

### (Step S103)

At step S103, the controller 11 operates as the determination unit 114 and determines whether the first control command 50 has been normally derived by the first control model 30 or not. In the present embodiment, an abnormality occurring in derivation of the first control command 50 may include at least any of an output failure of the first control command 50 occurring, the reliability of output of the first control model 30 being below the threshold, or the amount of change in the output of the first control model 30 per unit time being above the threshold. If determining that the first control command 50 has been normally derived, the controller 11 advances the process to step S104. On the other hand, if determining that an abnormality has occurred in derivation of the first control command 50, the controller 11 advances the process to step S105.

### (Step S104)

At step S104, the controller 11 operates as the operation controller 116 and controls operation of the mobile body M according to the derived first control command 50. The controller 11 may directly or indirectly control the operation of the target mobile body M. When the control of the target mobile body M is completed, the controller 11 ends the process procedure of the control device 1 according to the present operation example.

### (Step S105)

At step S105, the controller 11 operates as the second derivation unit 113 and tries derivation of the second control command 55 using the second control model 35. In the present embodiment, the second control model 35 is configured to be capable of normally deriving a control command in at least a part of scenes of an abnormality occurring in derivation of a control command by the first control model 30, by being different from the first control model 30 in at least any of the type and input data. In one example, the first control model 30 is configured with a trained machine learning model while the second control model 35 may be configured with a rule-based model. In another example, the first control model 30 is configured with a trained machine learning model, and the second control model 35 may be configured with a trained machine learning model the input data of which is at least partially different from that of the first control model 30.

A process for deriving the second control command 55 may be appropriately decided according to each embodiment similarly to the process for the first control command 50. As one example, when the second control model 35 includes a trained machine learning model, the controller 11 may acquire a result of derivation of the second control command 55 by inputting at least a part of the acquired observation data 125 to the second control model 35 and executing arithmetic processing of the second control model 35. The controller 11 refers to the second model data 350 at any timing before implementing step S105 to set up the second control model 35 into a state in which the arithmetic processing can be executed. As another example, when the second control model 35 includes a rule-based model, the controller 11 refers to the second model data 350 to derive the second control command 55 from an environment shown by at least a part of the observation data 125 according to rules specified by the rule-based model. When the rule-based model includes an analysis model, the controller 11 may recognize a surrounding environment of the mobile body M from at least the part of the observation data 125 using the analysis model and derive the second control command 55 from a result of the recognition according to the rules.

When having tried derivation of the second control command 55, the controller 11 advances the process to the next step S106. In the example of FIG. 7, if an abnormality has occurred in derivation of the first control command 50, as a result of the determination of step S103, the processing of step S105 is executed. The processing timing of step S105, however, is not limited to such an example. The processing of step S105 may be executed at any timing regardless of the result of the determination of step S103. As another example, the processing of step S105 may be at least partially executed in parallel with the processing of step S102.

### (Step S106)

At step S106, the controller 11 operates as the determination unit 114 and determines whether the second control command 55 has been normally derived by the second control model 35 or not. In the present embodiment, similarly to the first control command 50, an abnormality occurring in derivation of the second control command 55 may include at least any of an output failure of the second control command 55 occurring, the reliability of output of the second control model 35 being below the threshold, or the amount of change in output of the second control model 35 per unit time being above the threshold. If determining that the second control command 55 has been normally derived, the controller 11 advances the process to step S107. On the other hand, if determining that an abnormality has occurred in derivation of the second control command 55, the controller 11 advances the process to step S108.

### (Step S107)

At step S107, the controller 11 operates as the operation controller 116 and controls the operation of the mobile body M according to the derived second control command 55. The controller 11 may directly or indirectly control the operation of the target mobile body M. When the control of the target mobile body M is completed, the controller 11 ends the process procedure of the control device 1 according to the present operation example.

### (Step S108)

At step S108, the controller 11 operates as the operation acceptance unit 115, accepts input of the manual operation 40 by the user, and acquires the third control command 60 originating from the inputted manual operation 40. When having received input of the manual operation 40 and acquired the third control command 60, the controller 11 advances the process to the next step S109.

In the example of FIG. 7, if abnormalities have occurred in both of the derivations of the first and second control commands 50 and 55, as a result of the determination of steps S103 and S106, the processing of step S108 is executed. The processing timing of step S108, however, may not be limited to such an example. The processing of step S108 may be executed at any timing regardless of the result of the determination of at least one of steps S103 and S106. In another example, the processing of step S108 may be executed regardless of the processing of all of steps S101 to S107.

Further, in the present embodiment, when step S108 is reached, the operation mode of the mobile body M is switched from the automatic control by the control model (the first control model 30 or the second control model 35) to the manual control. At the time of switching to the manual control, the controller 11 may execute any transition processing (for example, processing for making a notification about switching to the manual mode). The timing of executing any transition processing may be appropriately decided according to each embodiment. Furthermore, when manual operation 40 is not obtained, for example, because of the user being in a state of not being able to perform an operation, the controller 11 may execute any emergency processing (for example, stopping the vehicle at a road shoulder). In this case, the controller 11 may omit the processing of the next step S109.

### (Step S109)

At step S109, the controller 11 operates as the operation controller 116 and controls the operation of the mobile body M according to the accepted manual operation 40. That is, the controller 11 controls the operation of the mobile body M according to the acquired third control command 60. The controller 11 may directly or indirectly control the operation of the target mobile body M. When the control of the target mobile body M is completed, the controller 11 ends the process procedure of the control device 1 according to the present operation example.

### Others

The controller 11 may repeatedly execute the series of information processing of steps S101 to S109. The repetition timing may be appropriately decided according to each embodiment. In one example, the controller 11 may repeatedly execute the series of information processing of steps S101 to S109 during a predetermined period (for example, from when the power source of the mobile body M is activated until it is stopped). Thereby, the control device 1 may continuously perform operation control of the mobile body M.

### [Characteristics]

In the present embodiment, the second control model 35 capable of deriving a control command from a different point of view is deployed together with the first control model 30. Thereby, in at least a part of scenes in which it is impossible to normally derive a control command with the first control model 30, normal derivation of a control command by the second control model 35 can be expected. In the processing of step S102, even if an abnormality occurs in derivation of the first control command 50 by the first control model 30, continuation of the automatic control can be expected by the processing of steps S105 and S107 using the second control model 35. Thereby, even if it is difficult to continue the automatic control by the first control model 30, it may be unnecessary to switch to the control by the manual operation 40 of steps S108 and S109. Therefore, according to the present embodiment, it is possible to reduce the frequency of control by a manual operation.

### 4. Modifications

An embodiment of the present disclosure has been described above in detail. The description so far, however, is a mere exemplification of the present disclosure in all points. It goes without saying that various improvements or modification can be made without departing from the scope of the present disclosure. For example, changes as described below are possible. Hereinafter, similar reference signs will be used for components similar to those of the above embodiment, and description of points similar to those of the above embodiment will be appropriately omitted. The following modifications can be appropriately combined.

### 4.1

In the above embodiment, whether execution of the control of the second control model 35 or execution of the control of the manual operation 40 is to be assigned is decided according to whether derivation of the second control command 55 is successful or not. The assignment method, however, may not be limited to such an example but may be appropriately decided according to each embodiment. In another example, together with or instead of the above embodiment, controlling movement of the mobile body M according to the second control command 55 or the third control command 60 may be configured with deciding which of the second control model 35 and the manual operation 40 is to be adopted, according to an environment of the movement of the mobile body M, deriving the second control command 55 using the second control model 35 and controlling the movement of the mobile body M according to the derived second control command 55 if it is decided to adopt the second control model 35, and controlling the movement of the mobile body M according to the third control command 60 originating from the manual operation 40 if it is decided to adopt the manual operation 40. In this form, the mobile body M may be a vehicle, and the environment of the movement of the mobile body M may include the type of a road where the vehicle travels.

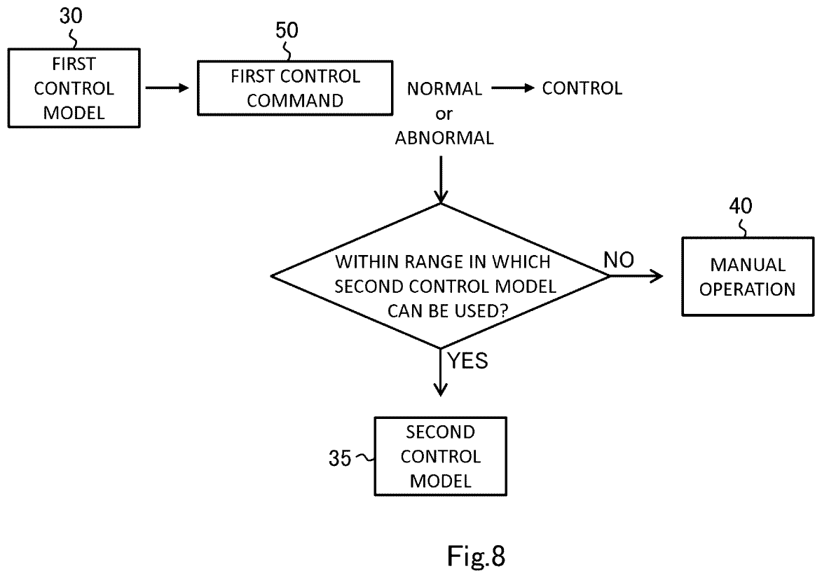

FIG. 8 schematically illustrates one example of a control process in the control device 1 according to the present modification. In the example of FIG. 8, the control device 1 tries derivation of the first control command 50 by the first control model 30. If the first control command 50 is normally derived as a result of the trial of derivation of the first control command 50, the control device 1 controls operation of the mobile body M according to the derived first control command 50. On the other hand, if an abnormality occurs in derivation of the first control command 50, the control device 1 decides which of the second control model 35 and the manual operation 40 is to be adopted, according to an environment of movement of the mobile body M at the time of control. In one example, the determination unit 114 may be configured to decide which of the second control model 35 and the manual operation 40 is to be adopted.

If it is decided to adopt the second control model 35, the control device 1 derives the second control command 55 using the second control model 35. Then, the control device 1 controls the operation of the mobile body M according to the derived second control command 55. On the other hand, if it is decided to adopt the manual operation 40, the control device 1 accepts input of the manual operation 40 and acquires the third control command 60 originating from the inputted manual operation 40. Then, the control device 1 controls the operation of the mobile body M according to the acquired third control command 60.

FIG. 9 illustrates one example of a process procedures for control of the mobile body M by the control device 1 according to the present modification. The process procedure below is one example of a control method executed by a computer. The process procedure below, however, is a mere example, and each step may be changed as far as possible. Further, as for the process procedure below, omission, replacement, and addition of steps can be appropriately performed according to each embodiment.

The process procedure illustrated in FIG. 9 may be similar to that of the above embodiment (FIG. 7) except that, after it is determined in the processing of step S103 that an abnormality has occurred in derivation of the first control command 50, processing of step S200 is executed before the processing of step S105.

At step S200, the control device 1 operates as the determination unit 114 and decides which of the second control model 35 and the manual operation 40 is to be adopted, according to an environment of movement of the mobile body M at the time of control. In one example, the controller 11 may decide which of the second control model 35 and the manual operation 40 is to be adopted, according to an environment shown by at least a part of the observation data 125 that has been acquired.

In the present modification, a range of environments that the second control model 35 can cope with may be set for the second control model 35. The controller 11 may decide which of the second control model 35 and the manual operation 40 is to be adopted, according to whether an environment of movement of the mobile body M is within the range or not. That is, if the environment of the movement of the mobile body M is within the range in which the second control model 35 can be used, the controller 11 may decide that the second control model 35 is to be adopted, and, otherwise, decide that the manual operation 40 is to be adopted.

In one example, when the mobile body M is a vehicle, the second control model 35 may be configured to perform automatic travel on a road of a particular type. In this case, the controller 11 may decide which of the second control model 35 and the manual operation 40 is to be adopted, according to the type of road where the vehicle travels. As a specific example, the second control model 35 may be configured to perform constant speed travel and inter-vehicle distance control (for example, ACC (adaptive cruise control)) on an expressway. In this case, the controller 11 may decide to adopt the second control model 35 if the type of a road where the vehicle (the mobile body M) is traveling is expressway, and, otherwise, decide to adopt the manual operation 40. Further, the control device 1 may hold a blacklist that specifies a range in which neither constant speed travel nor inter-vehicle distance control is executed, on an expressway. The blacklist may be appropriately generated (for example, may be obtained by setting by the user). In this case, if a road where the vehicle (the mobile body M) is traveling is within a range on an expressway that is not included in the blacklist, at the time of control, the controller 11 may decide to adopt the second control model 35. On the other hand, if the road where the vehicle is traveling is within the range on the expressway that is included in the blacklist or if the type of the road where the vehicle is traveling is other than expressway (for example, general road), the controller 11 may decide to adopt the manual operation 40.

In another example, the controller 11 may decide which of the second control model 35 and the manual operation 40 is to be adopted, according to whether or not an environment of movement of the mobile body M is within a range in which data to be used by the second control model 35 can be acquired. As a specific example, when the second control model 35 uses map information to derive the second control command 55, the controller 11 may decide to adopt the second control model 35 if the current position of the vehicle (the mobile body M) is in a range covered by the map information, and, otherwise, decide to adopt the manual operation 40. Further, when the sensors S include a GPS module, and the second control model 35 uses position information measured by the GPS module to derive the second control command 55, the controller 11 may decide to adopt the second control model 35 if the current position of the vehicle (the mobile body M) is within a measurement section of the GPS module, and, otherwise, decide to adopt the manual operation 40.

If having decided to adopt the second control model 35, the controller 11 advances the process to step S105. On the other hand, if having decided to adopt the manual operation 40, the controller 11 advances the process to step S108. In the example of FIG. 9, if an abnormality has occurred in derivation of the first control command 50, as a result of the determination of step S103, the processing of step S200 is executed. The processing timing of step S200, however, is not limited to such an example. The processing of step S200 may be executed at any timing regardless of the result of the determination of step S103. As another example, the processing of step S200 may be at least partially executed in parallel with the processing of at least any of steps S101 to S103. According to the present modification, in scenes in which the automatic control by the second control model 35 is certainly impossible, the control can be switched to the control by the manual operation 40, with the determination processing of step S106 being omitted. Thereby, the efficiency of the control process can be improved.

### 4.2

In the above embodiment, each of the number of first control models 30 and the number of second control models 35 is one for convenience of the description. Each of the number of first control models 30 and the number of second control models 35, however, may not be limited to one but may be freely decided. At least either the number of first control models 30 or the number of second control models 35 deployed in the control device 1 may be two or more.

In one example, the control device 1 may have a different first control model 30 and a different second control model 35 for each of scenes. When the mobile body M is a vehicle, the scenes may be, for example, lane change, lane keeping, and emergency stop (EDSS: Emergency Driving Stop System). In this case, the control device 1 may switch the first control model 30 and second control model 35 to be used, for each of the scenes.

Further, the control device 1 may hold a plurality of second control models 35 for one first control model 30. That is, the number of second control models 35 used to support one first control model 30 does not have to be limited to one but may be freely decided. For one first control model 30, a plurality of second control models 35 may be deployed to support the first control model 30. In the present modification, if an abnormality occurs in derivation of the first control command 50 by the first control model 30, the control device 1 may derive the second control command 55 by one or more second control models 35 among the plurality of second control models 35. The plurality of second control models 35 may be referred to, for example, as a second control model, a third control model, . . . , and an N-th control model in order.

### 5. Supplementary Information

The processes and means described in the present disclosure can be freely combined and implemented unless technical contradiction occurs.

Further, a process described as being performed by one apparatus may be shared and executed by a plurality of apparatuses. Or alternatively, processes described as being performed by different apparatuses may be executed by one apparatus. In a computer system, which hardware component is used to realize each function can be flexibly changed.

The present disclosure can be realized by supplying a computer program implemented with the functions described in the above embodiment to a computer, and one or more processors of the computer reading out and executing the program. Such a computer program may be provided for the computer by a non-transitory computer-readable storage medium connectable to a system bus of the computer or may be provided for the computer via a network. The non-transitory computer-readable storage medium includes, for example, any type of disk such as a magnetic disk (a floppy (registered trademark) disk, a hard disk drive (HDD), or the like) and an optical disc (a CD-ROM, a DVD disc, a Blu-ray disc, or the like), a read-only memory (ROM), a random-access memory (RAN), an EPROM, an EEPROM, a magnetic card, a flash memory, an optical card, a semiconductor drive (such as a solid state drive), and any type of medium that is appropriate for storing electronic commands.

What is claimed is:

1. A control device comprising:
a storage configured to store a first control model and a second control model; and
a processor; wherein
the second control model is configured to be capable of normally deriving a control command in at least a part of scenes of an abnormality occurring in derivation of a control command by the first control model, by being different from the first control model in at least any of a type and input data; and
the processor is configured to execute:
trying derivation of a first control command using the first control model;
controlling, if the derivation of the first control command by the first control model is normal, movement of a mobile body according to the derived first control command; and
controlling, if an abnormality occurs in the derivation of the first control command by the first control model, the movement of the mobile body according to a second control command derived by the second control model or a third control command originating from a manual operation by a user.

2. The control device according to claim 1, wherein
the first control model is configured with a trained machine learning model; and
the second control model is configured with a rule-based model.

3. The control device according to claim 1, wherein
the first control model is configured with a trained machine learning model; and
the second control model is configured with such a trained machine learning model that input data is at least partially different from input data of the first control model.

4. The control device according to claim 1, wherein
controlling the movement of the mobile body according to the second control command or the third control command is configured with:
deciding which of the second control model and the manual operation is to be adopted, according to an environment of the movement of the mobile body;
deriving, if it is decided that the second control model is to be adopted, the second control command using the second control model and controlling the movement of the mobile body according to the derived second control command; and
controlling, if it is decided that the manual operation is to be adopted, the movement of the mobile body according to the third control command originating from the manual operation.

5. The control device according to claim 4, wherein
the mobile body is a vehicle; and
the environment of the movement of the mobile body includes a type of a road where the vehicle travels.

6. The control device according to claim 1, wherein
controlling the movement of the mobile body according to the second control command or the third control command is configured with:
controlling, if the derivation of the second control command by the second control model is normal, the movement of the mobile body according to the derived second control command; and
controlling, if an abnormality occurs in the derivation of the second control command by the second control model, the movement of the mobile body according to the third control command originating from the manual operation.

7. The control device according to claim 1, wherein
the abnormality occurring in the derivation of the first control command includes an output failure of the first control model occurring.

8. The control device according to claim 1, wherein
the abnormality occurring in the derivation of the first control command includes reliability of output of the first control model being below a threshold.

9. The control device according to claim 1, wherein
the abnormality occurring in the derivation of the first control command includes an amount of change in the output of the first control model per unit time being above a threshold.

10. A non-transitory storage medium storing a control program for causing a control device, the control device holding a first control model and a second control model configured to be capable of normally deriving a control command in at least a part of scenes of an abnormality occurring in derivation of a control command by the first control model, by being different from the first control model in at least any of a type and input data, to execute:
trying derivation of a first control command using the first control model;
controlling, if the derivation of the first control command by the first control model is normal, movement of a mobile body according to the derived first control command; and
controlling, if an abnormality occurs in the derivation of the first control command by the first control model, the movement of the mobile body according to a second control command derived by the second control model or a third control command originating from a manual operation by a user.

11. The non-transitory storage medium according to claim 10, wherein
the first control model is configured with a trained machine learning model; and
the second control model is configured with a rule-based model.

12. The non-transitory storage medium according to claim 10, wherein
the first control model is configured with a trained machine learning model; and
the second control model is configured with such a trained machine learning model that input data is at least partially different from input data of the first control model.

13. The non-transitory storage medium according to claim 10, wherein
controlling the movement of the mobile body according to the second control command or the third control command is configured with:
deciding which of the second control model and the manual operation is to be adopted, according to an environment of the movement of the mobile body;
deriving, if it is decided that the second control model is to be adopted, the second control command using the second control model and controlling the movement of the mobile body according to the derived second control command; and
controlling, if it is decided that the manual operation is to be adopted, the movement of the mobile body according to the third control command originating from the manual operation.

14. The non-transitory storage medium according to claim 13, wherein
the mobile body is a vehicle; and
the environment of the movement of the mobile body includes a type of a road where the vehicle travels.

15. The non-transitory storage medium according to claim 10, wherein
controlling the movement of the mobile body according to the second control command or the third control command is configured with:
controlling, if the derivation of the second control command by the second control model is normal, the movement of the mobile body according to the derived second control command; and
controlling, if an abnormality occurs in the derivation of the second control command by the second control model, the movement of the mobile body according to the third control command originating from the manual operation.

16. The non-transitory storage medium according to claim 10, wherein
the abnormality occurring in the derivation of the first control command includes an output failure of the first control model occurring.

17. The non-transitory storage medium according to claim 10, wherein
the abnormality occurring in the derivation of the first control command includes reliability of output of the first control model being below a threshold.

18. The non-transitory storage medium according to claim 10, wherein
the abnormality occurring in the derivation of the first control command includes an amount of change in the output of the first control model per unit time being above a threshold.

19. A control method for a control device, the control device holding a first control model and a second control model configured to be capable of normally deriving a control command in at least a part of scenes of an abnormality occurring in derivation of a control command by the first control model, by being different from the first control model in at least any of a type and input data, to execute:
trying derivation of a first control command using the first control model;
controlling, if the derivation of the first control command by the first control model is normal, movement of a mobile body according to the derived first control command; and
controlling, if an abnormality occurs in the derivation of the first control command by the first control model, the movement of the mobile body according to a second control command derived by the second control model or a third control command originating from a manual operation by a user.

20. The control method according to claim 19, wherein
controlling the movement of the mobile body according to the second control command or the third control command is configured with:
deciding which of the second control model and the manual operation is to be adopted, according to an environment of the movement of the mobile body;
deriving, if it is decided that the second control model is to be adopted, the second control command using the second control model and controlling the movement of the mobile body according to the derived second control command; and
controlling, if it is decided that the manual operation is to be adopted, the movement of the mobile body according to the third control command originating from the manual operation.
